(19) United States
(12) Patent Application Publication
(10) Pub. No.: US 2004/0119911 A1
(43) Pub. Date: Jun. 24, 2004

(54) Liquid crystal display device and liquid crystal production method

(75) Inventors: Kouji Ooae, Kitasoma-gun (JP); Ryuzo Fukao, Kitasoma (JP); Yuji Yamashita, Kitasoma-gun (JP)

Correspondence Address: BIRCH STEWART KOLASCH & BIRCH, PO BOX 747, FALLS CHURCH, VA, 22040-0747, US

(73) Assignee: Hitachi Maxell, Ltd.

(21) Appl. No.: 10/626,773

(22) Filed: Jul. 25, 2003

Related U.S. Application Data
(63) Continuation of application No. 09/831,740, filed on May 14, 2001, now abandoned.
Application No. 09/831,740 is a 371 of international application No. PCT/JP99/06610, filed on Nov. 26, 1999.

(30) Foreign Application Priority Data
Nov. 27, 1998 (JP) 10-336922
Dec. 18, 1998 (JP) 10-360396
Feb. 9, 1999 (JP) 11-031339

(51) Int. Cl. G02F 1/1333

(52) U.S. Cl. 349/86

(57) ABSTRACT

A thermal-responsive liquid crystal display having a polymer dispersed liquid crystal layer formed to have excellent response speed, good display characteristics, uniform thickness distribution, high thickness, high contrast and excellent resistance to thermal cycle. A polymer dispersed liquid crystal layer formed of a composition of a polymer and a liquid crystal is provided on a heating unit. The polymer is a thermoplastic resin, and the glass transition temperature (T_{g}) of the resin and the phase transition temperature (T_{NI}) of the liquid crystal satisfy the condition of −20≦(T_{g}−T_{NI})≦20 (° C.). The polymer dispersed liquid crystal layer is formed by laminating a plurality of polymer dispersed liquid crystal films.

### TECHNICAL FIELD

The present invention generally relates to liquid crystal displays, and particularly to a liquid crystal display formed of a polymer dispersed liquid crystal layer having thermooptic effect or thermal response characteristic that includes a liquid crystal material, and a heating unit for driving this polymer dispersed liquid crystal layer.

### PRIOR ART

Liquid crystal materials of which the optical characteristics are changed by temperature change have so far been used for the display of images. The liquid crystal materials for the display include smectic liquid crystal, nematic liquid crystal and cholesteric liquid crystal. It is known that these liquid crystal materials become transparent or opaque (clouded) or cause change of color when the molecular orientation of liquid crystal is changed by temperature change.

On the other hand, display devices using polymer dispersed liquid crystal have been developed. This type of devices have excellent characteristics such as high brightness, high contrast and wide visual field angle as compared with the generally used liquid crystal display devices with polarization. In addition, since liquid crystal is dispersed within the polymer, there is no need to seal the liquid crystal. In a liquid crystal display device using a thermal-responsive polymer dispersed liquid crystal, a polymer dispersed liquid crystal mixture is prepared by dispersing a kind of nematic liquid crystal within a polymer. FIG. 1(a) shows the non-heated state (nematic mode) of the polymer dispersed liquid crystal layer using this mixture, and FIG. 1(b) the heated state (isotropic mode) of the layer. FIG. 2 shows the relation between temperature and refractive index of this layer.

As shown in FIGS. 1(a) and 2, when the layer is not heated, it is clouded, or opaque. Since the liquid crystal molecules are orientated along the interface between the liquid crytal droplet and the polymer, there is a difference Δn (Δn=nₑ−nₚ) between the refractive index, nₚ of a polymer resin 101 and nₑ of a liquid crytal droplet 102. Thus, light is scattered at the interface between the polymer resin and the liquid crystal droplet.

As illustrated in FIGS. 1(b) and 2, when the layer is heated above the transition temperature T_{NI}, where liquid crystal transfer from nematic to isotropic, it changes from the transparent. Since the liquid crystal molecules in the layer are heated to above T_{NI}, thus losing the characteristics of liquid crystal, the refractive index is changed down from the nematic-state index nₑ to the isotropic-state index nᵢ. As a result, the difference, Δn′ (Δn′=nᵢ−nₚ) between the refractive index nᵢ of droplet 103 and nₚ of the polymer resin reduces above T_{NI}.

However, various problems still remain in this type of display devices. For example, (1) the thermal conductivity of the polymer is low, and then response speed is insufficient, (2) contrast is not uniform because temperature distribution over the device is not even, and (3) in case of matrix-addressing display, image becomes dim because of unclear pixell outline. These problems are probably caused by the poor thermal response characteristic of this device since it includes polymer having low thermal conductivity. Further, (4) the polymer is gradually deformed due to the affection of the repetitive thermal cycles, reducing the practical device life.

In order to increase the display contrast of the device, it is appreciated that the both levels of opaque and transparent state are required to improve. The opaque level is improved by (1) increase of the layer thickness, (2) dispersing the liquid crystal droplets uniformly in the polymer, and (3) using polymer and liquid crystal materials of which refractive indexes are largely different. The item (1) is the most effective, and it can be simply achieved by increasing the blade gap at the production (time).

The thickness of the polymer dispersed liquid crystal layer becomes large with increasing the amount of the mixture ink. Generally, the ink is coated on the substrate by a coating device such as doctor blade. However, when a large amount of ink is coated on the substrate with the wide gap blade, of the coating device such as doctor blade, the layer is not uniform in thickness at the coating start point, central point and end point on the substrate. Thus the uniform coating is difficult.

Double coating method is considered to be used. However, when the second layer is coated, solvent in the ink affects the first layer, dissolving it so that the obtained layer does not have the thickness as designed (for example, double the thickness of the first layer when the final coating is the second). Thus it is difficult to prepare the polymer dispersed liquid crystal layer of a desired thickness.

### DISCLOSURE OF INVENTION

Accordingly, it is an object of the invention to provide a polymer dispersed liquid crystal display of thermal response type that is excellent in the response speed and display characteristics.

It is another object of the invention to provide a polymer dispersed liquid crystal display that is excellent in thermal response and thermal stability.

It is still another object of the invention to provide a polymer dispersed liquid crystal display formed of a polymer dispersed liquid crystal layer that has a uniform thickness distribution, of which the thickness is large and that provides a high contrast.

The first object of the invention can be solved by providing a polymer dispersed liquid crystal layer formed of a composition of a polymer and a liquid crystal on a heating unit held between a pair of electrodes. In this case, the pair of electrodes are connected to the left and right ends of the heating unit or to the upper and lower surfaces of the heating unit. In the former case, the polymer dispersed liquid crystal layer is connected directly to the heating unit, but in the latter case, one of the paired electrodes is interposed between the polymer dispersed liquid crystal layer and the heating unit.

The second object of the invention is solved by using thermoplastic resin as the polymer of the composition that is formed of the polymer and a liquid crystal and by which the polymer dispersed liquid crystal layer is formed, and by selecting the glass transition temperature (T_{g}) of the polymer to be larger than the phase transition temperature (T_{NI}) of the liquid crystal.

The third object of the invention can be solved by sequentially superimposing a plurality of separately formed liquid crystal films to form a single laminated structure liquid crystal layer having a large film thickness.

### BRIEF DESCRIPTION OF DRAWINGS

FIGS. 1(a) and 1(b) are diagrams showing the non-heated and heated modes of a polymer dispersed liquid crystal, respectively.

FIG. 2 is a graph showing the relation of the refractive index of the polymer dispersed liquid crystal with the temperature thereof.

FIG. 3 is a perspective cross-sectional view of one embodiment of a liquid crystal display according to the invention.

FIGS. 4(a) and 4(b) are perspective cross-sectional views of the liquid crystal display of FIG. 3 according to the invention before and after the voltage application, respectively.

FIGS. 5(a) and 5(b) are perspective cross-sectional views of a modification of the liquid crystal display of FIG. 3 with a reflecting plate inserted and with a color film inserted, respectively.

FIGS. 6(a) and 6(b) are cross-sectional views of still another modification of the liquid crystal display of FIG. 3 with a thermal conduction plate inserted, and with a thermal conduction plate and reflecting plate inserted, respectively.

FIGS. 7(a) and 7(b) are top views showing the effect of not using and using the thermal conduction plate, respectively.

FIG. 8 is a modification of the structure of FIG. 6(a) with a plurality of divided thermal conduction plates inserted.

FIG. 9 is a diagram showing one example of the display change of the polymer dispersed liquid crystal layer when the liquid crystal display 300 having the structure illustrated in FIG. 8 is driven.

FIG. 10 is a cross-section view of another modification of the structure of FIG. 6(a) with an opening 1001 provided in the surface of a thermal conduction plate 601.

FIG. 11 is a top view of one example of a matrix type liquid crystal display.

FIG. 12 is a cross-sectional view taken along a line A-A in FIG. 11.

FIG. 13 is a timing chart of pulse for driving switches (sw) A1 to A3, and B1 to B3 to display as illustrated in FIG. 11.

FIG. 14 is a graph showing the mode change of the polymer dispersed liquid crystal layer in the liquid crystal display of the matrix structure according to the invention.

FIG. 15 is a cross-sectional view of one example of a matrix type liquid crystal display 1500 with a protective film 301 and polymer dispersed liquid crystal layer 302 formed in a single continuous sheet.

FIG. 16 is a top view of the matrix type liquid crystal display 1500 of FIG. 15.

FIGS. 17(a) and 17(b) are top views showing the effect of not using and using a cooling body, respectively.

FIGS. 18(a) and 18(b) are graphs showing the relation between the voltage applied to the heating unit and the temperature of the polymer dispersion type liquid crystal layer with no temperature control and with temperature control by the change of voltage pulse width applied to the heating unit, respectively.

FIG. 19 is a block diagram showing a method of setting the voltage pulse width applied to the heating unit in the liquid crystal display of the matrix structure according to the invention.

FIG. 20 is a cross-sectional view of the structure of another embodiment of a liquid crystal display according to the invention.

FIG. 21 is a cross-sectional view of the structure of still another embodiment of a liquid crystal display according to the invention.

FIG. 22 is a cross-sectional view of the structure of further another embodiment of a liquid crystal display according to the invention.

FIG. 23 is a plan view of one example of the heating unit used in the liquid crystal display according to the invention.

FIG. 24 is a plan view of one example of electrode a.

FIG. 25 is a partially magnified perspective view of part A in FIG. 24.

FIG. 26 is a plan view of one example of the thermal conduction plate.

FIG. 27 is a plan view of one example of the grid type thermal conduction plate.

FIG. 28 shows one example of the production process for producing a laminated polymer dispersed liquid crystal layer according to the invention.

FIGS. 29(a), 29(b) and 29(c) are cross-sectional views of the laminated polymer dispersion type liquid crystal layer according to the invention with the polymer dispersed liquid crystal film and UV resistant polymer dispersed liquid crystal film formed, with heat and shock resistant polymer dispersed liquid crystal film, polymer dispersed liquid crystal film and UV resistant polymer dispersed liquid crystal film formed and with the polymer dispersed liquid crystal film interposed between high-ductility polymer dispersed liquid crystal films, respectively.

FIG. 30 is a graph showing the relation among the film thickness, transmission factor at the time of heating and transmission factor at the time of not heating, of the polymer dispersed liquid crystal layer of the laminated polymer dispersed liquid crystal layer according to the invention.

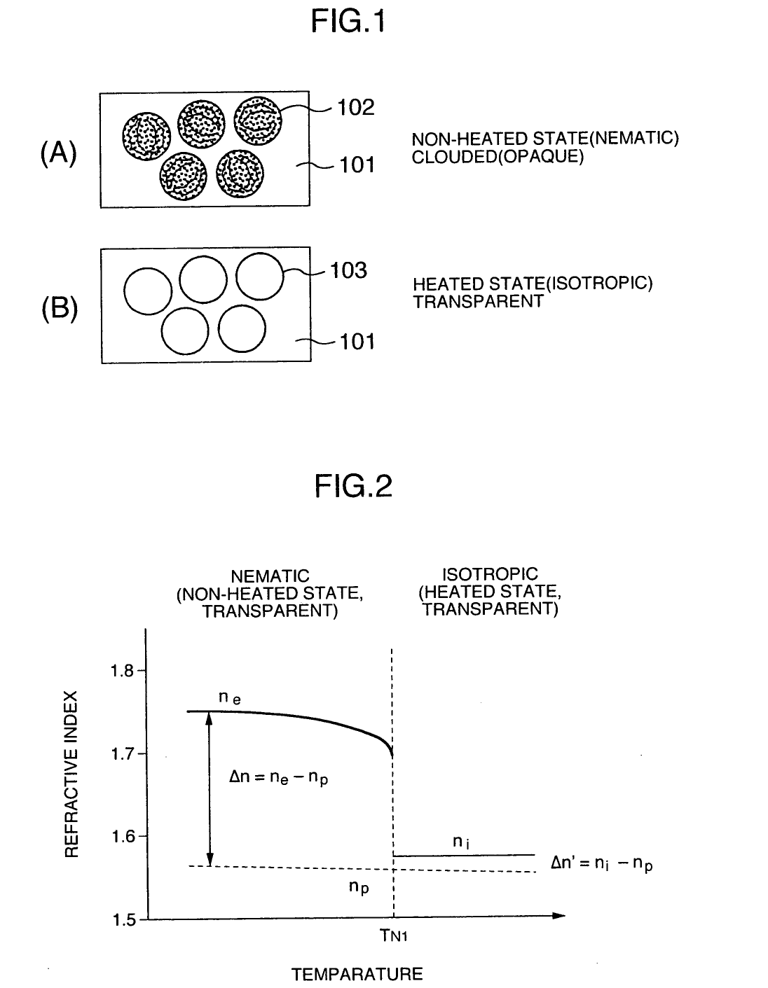

### BEST MODE FOR CARRYING OUT THE INVENTION

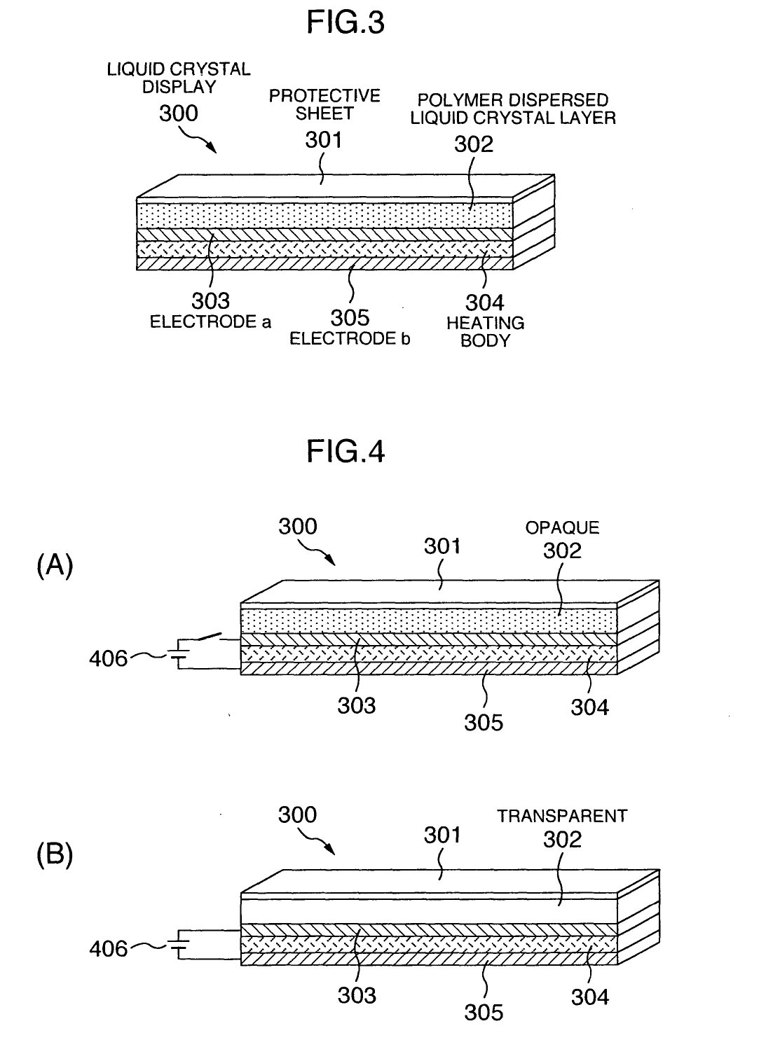

Embodiments of a liquid crystal display of the invention will be described in detail with reference to the accompanying drawings. FIG. 3 is a perspective cross-sectional view of one embodiment of the liquid crystal display 300 according to the invention. As illustrated, the liquid crystal display 300 of the invention is fundamentally formed of a protective sheet 301, a polymer dispersed liquid crystal layer 302, an electrode (a) 303, a heating unit 304 and an electrode (b) 305.

The protective sheet 301 is generally used to protect the underlying polymer dispersed liquid crystal layer 302. The protective sheet 301 is desirably transparent from the standpoint of easy visual recognition, and may be made of a transparent plastic material or glass as a typical material. Since the transparent plastic material is inexpensive as compared with glass, and can be made in a curved surface because of its flexible property, it is desirable particularly in this invention. The plastic protective sheet that can be used in the liquid crystal display of the invention may be made of, for example, polyethylene terephthalate or polyethylene naphthalate. Since the sheet of such material is heated by the heating unit 304, it is desired to have a high resistance to the temperature. Since the polymer dispersed liquid crystal layer 302 is generally heated to about 70° C. by the heating unit 304, the plastic protective sheet should have a heat resistance to temperatures of about 100˜120° C. The thickness of the protective sheet is not particularly limited, but generally should be set in a range of 20 μm˜400 μm. If the thickness is less than 20 μm, the mechanical strength is too low for enough protection effect to be expected. If the thickness is over 400 μm, the protective effect is not only saturated not to be economical, but the visual recognition property might be deteriorated.

The electrodes (a) 303, (b) 305 can be made of good conductor, metal plate such as aluminum, copper, silver or gold. These metal conductors are also generally excellent in thermal conductivity, and thus can transmit the heat generated from the heating unit 304 directly to the polymer dispersed liquid crystal layer 302. The electrodes (a) 303, (b) 305 can be made of the same kind of metal or different kinds of metal. Preferably, the electrodes (a) 303, (b) 305 should be made of the same kind of metal. The thickness of the electrodes (a) 303, (b) 305 is not particularly limited, but should be enough to satisfactorily conduct current.

The heating unit 304 provided between the electrodes (a) 303, (b) 305 has electric resistance by which heat is generated when an electric current is caused to flow in the heating unit between the electrodes. The resistance value of the heating unit is usually selected to be higher than that of the electrodes. For example, carbon or nickel is used for the heating unit 304 but may be replaced by other materials. The thickness of the heating unit 304 is not particularly limited, but the heating unit should have an ability to generate enough heat necessary for driving the polymer dispersed liquid crystal layer 302 at a desired response speed. This heat generating ability can be easily determined by referring to the specification of the heating unit or by repetition of experiments as those skillful in the art can understand.

FIGS. 4(a) and 4(b) are perspective cross-sectional views of the liquid crystal display 300 of FIG. 3 with the power supply turned off (before a voltage is applied) and with the power supply turned on (when a voltage is applied), respectively. The polymer of the polymer dispersed liquid crystal layer 302 was polyvinyl butyral, and the liquid crystal material was nematic liquid crystal that was clouded when not heated but became transparent when heated. The polymer dispersed liquid crystal layer 302 was produced by the solvent evaporation phase separation, and the weight ratio of polymer and liquid crystal was 1:1. The thickness of polymer dispersion liquid crystal layer 302 was 60 μm, the heating unit 304 was made of carbon, and the electrodes (a) 303, (b) 305 were made of copper foil. The power supply 406 may be either DC power supply such as primary cell or secondary cell, or AC-converted DC power supply.

Before the voltage from the power supply 406 was applied to the electrodes (a) 303, (b) 305, the polymer dispersion liquid crystal 302 was opaque and thus clouded when viewing from the top. When the voltage from the power supply 406, for example, DC 9 V was applied between the electrodes (a) 303, (b) 305, current flowed in the heating unit 304 of carbon, generating heat. When the temperature arrived at about 60° C., the polymer dispersed liquid crystal layer 302 changed from the clouded state to transparent state, with the result that copper color of electrode (a) 303 appeared. When the electrode (a) 303 of aluminum was used, silver color appeared.

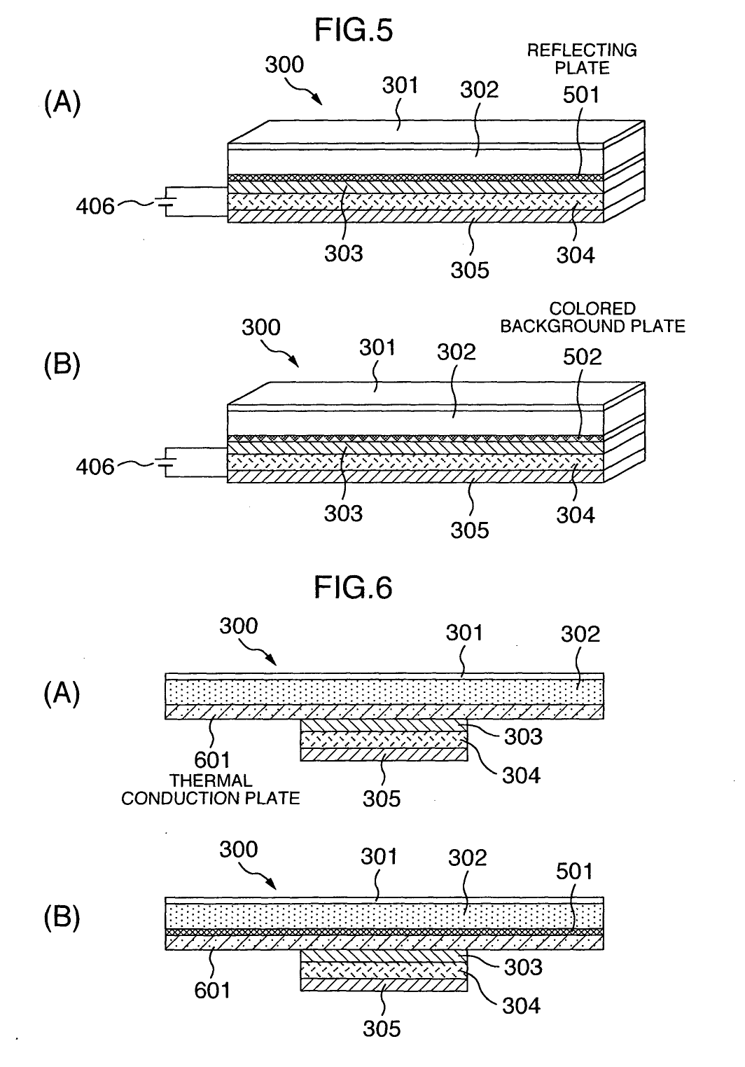

As illustrated in FIG. 5(a), a reflecting plate 501 having a high reflection factor can be placed between the polymer dispersed liquid crystal layer 302 and the electrode (a) 303. In this case, the reflection factor can be increased when the polymer dispersed liquid crystal layer 302 becomes transparent. The reflecting plate suitable for such purpose can be made of, for example, silver, aluminum, tin, nickel, chromium or platinum. The thickness of the reflecting plate is not particularly limited, but generally should be set in a range of 5 μm˜100 μm. If the thickness is less than 5 μm, the reflecting plate might be broken or twisted in the production process. If the thickness is over 100 μm, the reflecting plate might adversely affect the thermal conduction between the heating unit 304 and the polymer dispersed liquid crystal layer 302.

As illustrated in FIG. 5(b), a colored background plate 502 can be inserted between the polymer dispersed liquid crystal layer 302 and the electrode (a) 303. The use of colored background plate 502 enables not only various kinds of color to be displayed when the polymer dispersed liquid crystal layer 302 becomes transparent but the change of liquid crystal layer to be clearly visually confirmed. The colored background plate 502 may be made of, for example, plastic (such as colored cellophane, or colored film of heat resistant plastic film made of polyester, polypropylene, polyether sulfone, polyethylene, polyvinyl chloride or polyvinylidene chloride), paper, glass or metal foil. Any other material can be used for the colored background plate provided that it has excellent heat resistance and heat conductivity. The thickness of the colored background plate 502 generally should be set in a range of 5 μm˜100 μm. If the thickness is less than 5 μm, the colored background plate might be broken or twisted in the production process. If the thickness is over 100 μm, the thermal conductivity is decreased with the result that the response speed is reduced.

When the colored background plate 502 has the same white color as the polymer dispersed liquid crystal layer 302 not heated, it is the same white as the polymer dispersed liquid crystal layer 302 when not heated and is still white when heated. Therefore, it is difficult to visually discriminate the change of the liquid crystal layer. However, as one modification of the above structure, letters, figures, symbols and/or patterns may be printed in black on the surface of the white colored background plate 502. In this case, when not heated, the polymer dispersed liquid crystal layer 302 is white, and the letters or the like on the background plate 502 cannot be seen. However, when heated, the liquid crystal layer becomes transparent, and the black letters or the like on the background plate 502 can be clearly seen.

When the colored background plate 502 is black, the polymer dispersed liquid crystal layer 302 is white when not heated, but it appears black when heated. Therefore, the change of the liquid crystal layer can be seen clearly. In this case, the black should be lusterless. The colored background plate 502 may be blue, red or green, but it should have low brightness and saturation and be near to black.

When the colored background plate 502 is silver color, the polymer dispersed liquid crystal layer 302 is white when not heated. At this time, since the background plate 502 of silver color reflects back the light transmitted through and scattered by the liquid crystal layer 302 (back scatter), the degree of the white increases as compared with that of the colored background plate 502. However, when heated, the liquid crystal layer appears silver as the color of the background plate 502, but it is difficult to discriminate the color change because the white before heating and the silver appearing after heating have a small brightness difference.

The insertion of the colored background plate 502 between the electrode (a) 303 and the polymer dispersed liquid crystal layer 302 deteriorates the thermal conduction between the electrode (a) 303 and the polymer dispersed liquid crystal layer 302, thus lowering the response speed of the liquid crystal layer. Thus, the colored background plate 502 can be replaced by a colored coating on the surface of the electrode (a) 303. The paint for the coating should be, for example, a synthetic resin material such as acryl paint. The color of the paint should be lusterless black similar to the colored background plate 502. Letters, figures, symbols and/or patterns can be printed with this black paint on the surface of the electrode (a) 303.

The structure shown in FIG. 3 may be used without problem for a liquid crystal display of which the display segment size is about 1-cm square or smaller, but for a large-size liquid crystal display over tens of cm it cannot evenly display over the entire area of the polymer dispersed liquid crystal layer because heat is not uniformly conducted. In addition, since both the heating unit and the electrodes are large-sized, the production of the display becomes complicated.

Thus, as illustrated in FIG. 6(a), a thermal conduction plate 601 can be inserted between the polymer dispersed liquid crystal layer 302 and the electrode (a) 303 and made in close contact with the polymer dispersed liquid crystal 302, thereby equalizing the thermal conduction from the heating unit 304 over the liquid crystal layer. This thermal conduction plate 601 makes the thermal conduction uniform, thus preventing the display from being irregular. When the liquid crystal layer is stopped from being heated, the thermal conduction plate 601 serves as a radiator, making the turn-off time short. In addition, another merit of using the thermal conduction plate 601 is that the heating unit and the electrodes can be small-sized as compared with the polymer dispersed liquid crystal layer.

Moreover, as illustrated in FIG. 6(b), the reflecting plate 501 shown in FIG. 5(a), if necessary, can be inserted between the polymer dispersed liquid crystal layer 302 and the thermal conduction plate 601. The reflecting plate 501 and the thermal conduction plate 601 can also be combined into a unitary body. In addition, the electrode (a) 303, the reflecting plate 501 and the thermal conduction plate 601 can be combined into one unitary body. Moreover, although not shown, the color film 502 shown in FIG. 5(b) can be used in place of the reflecting plate 501.

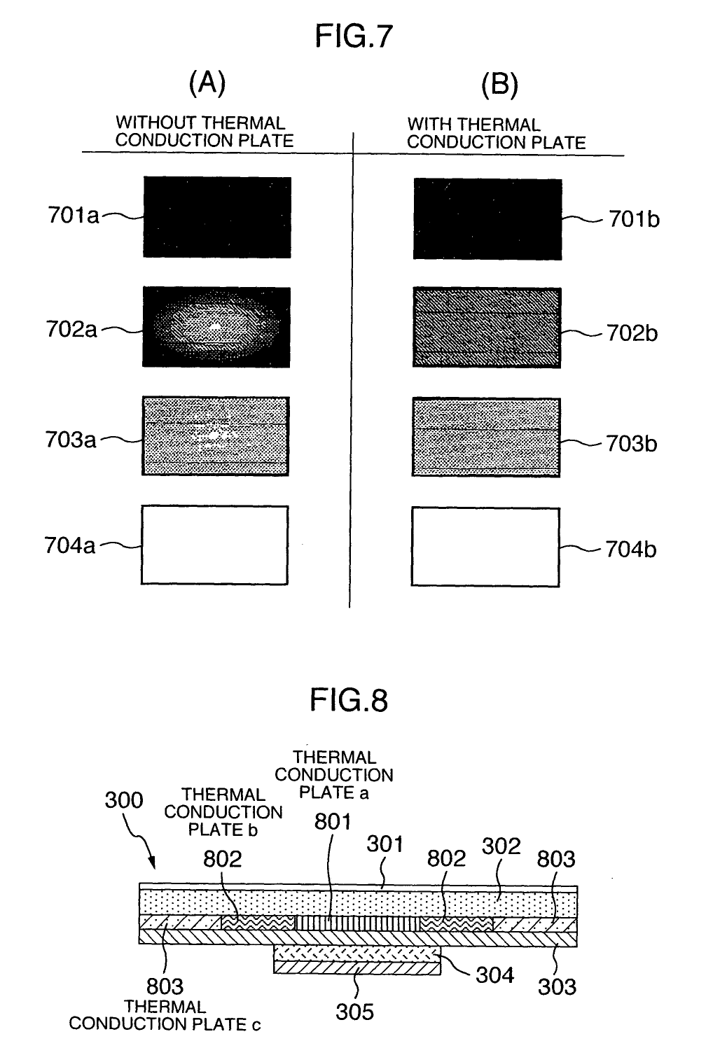

FIGS. 7(a) and 7(b) show the effects of not using and using the thermal conduction plate 601, respectively. When the thermal conduction plate 601 is not used, since the heat from the heating unit 304 is conducted unevenly to the polymer dispersed liquid crystal layer 302, display irregularities 702a, 703a are caused during the process from an opaque state 701a to a transparent state 704a. When the thermal conduction plate 601 is used as in FIG. 7(b), no display irregularity is caused during the process from the opaque state 701b to the transparent state 704b as seen from 702b and 703b, or the display state changes uniformly throughout the process.

FIG. 8 is a cross-sectional view of another example of the liquid crystal display 300 with a plurality of thermal conduction plates 801, 802, 803 having different thermal conductivities being inserted between the polymer dispersed liquid crystal layer 302 and the electrode 303 as an application of the thermal conduction plate 601. As illustrated in FIG. 8, the thermal conduction plate (a) 801 having a thermal conductivity (a), and the thermal conduction plate (b) 802 having a thermal conductivity (b) are inserted as the center segment and as both side segments between the polymer dispersed liquid crystal layer 302 and the electrode 303, respectively. In addition, the thermal conduction plate (c) 803 having a thermal conductivity (c) is inserted as the outermost segments therebetween. It is assumed that the thermal conductivities (a), (b), (c) satisfy the condition of a<b<c.

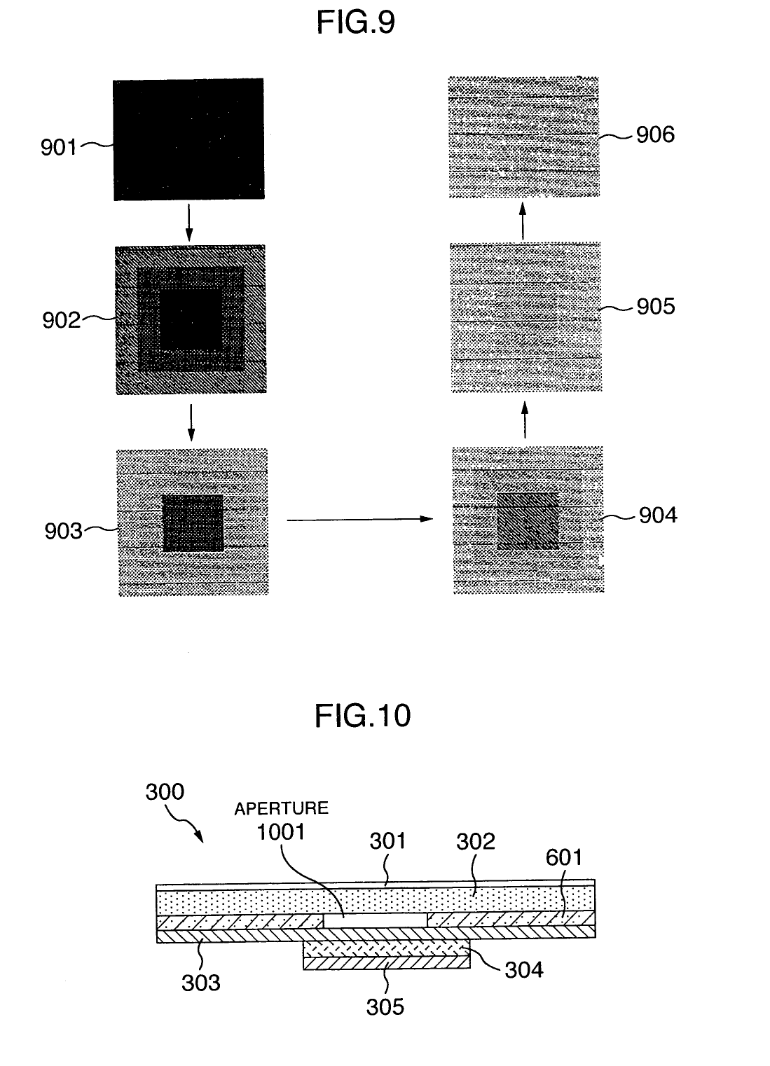

FIG. 9 shows one example of the change of the displaying state when the liquid crystal display 300 having the structure shown in FIG. 8 is driven. When a voltage is applied to the heating unit 304, the displaying state of the peripheral segments changes faster than that of the central segments since the thermal conduction plate (c) 803 faster conducts heat than the thermal conduction plates (b) 802 and (a) 801 that are located at the central portion (see 901˜904 in FIG. 9). In addition, since the thermal conduction plate (b) 802 faster conducts heat than the thermal conduction plate (a) 801, the state of the central portion changes last (see 905˜906 in FIG. 9). Thus, by using the thermal conduction plates that transmit heat at different speeds, it is possible to change the displaying state of the liquid crystal layer 302 in a phased manner. For example, fade-in or fade-out can be executed.

FIG. 10 shows another example different from the above structure in which a plurality of thermal conduction plates having different thermal conductivities are inserted between the polymer dispersed liquid crystal layer 302 and the electrode. As illustrated, at least one or more apertures or gaps 1001 are provided in the thermal conduction plate 601 at predetermined places (for example, at the central portion). Since the heat transmission speeds in those central portions and other portions are different, the polymer dispersed liquid crystal layer 302 can be turned on and off in a phased manner.

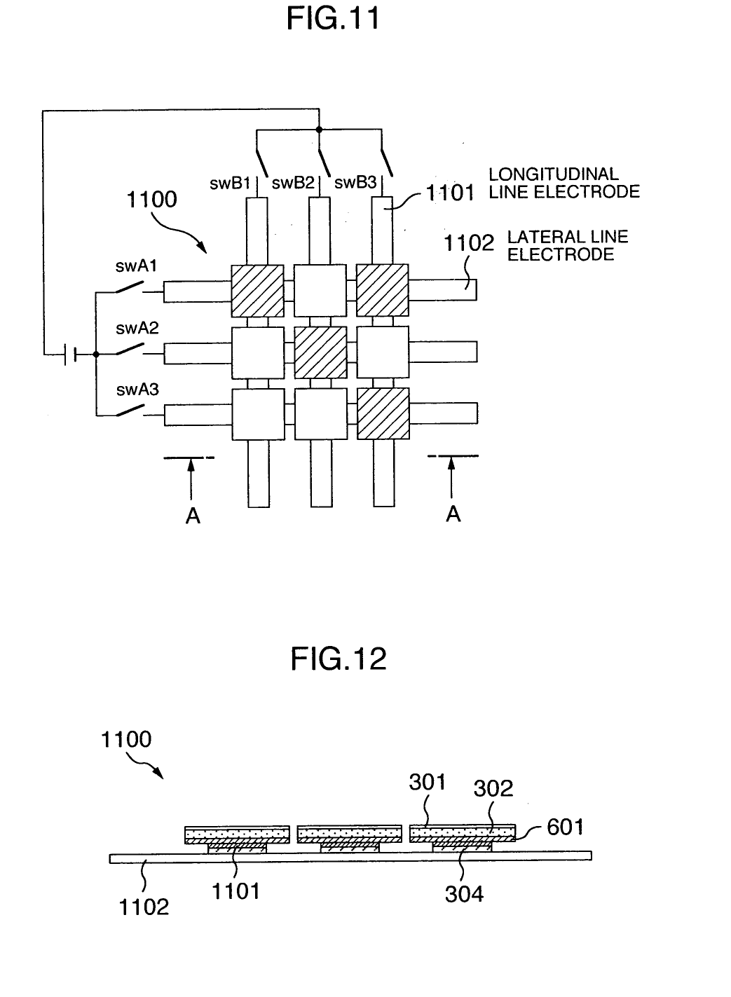

The liquid crystal display of the invention can also be constructed as a matrix type display. FIG. 11 is a plan view of one example of a liquid crystal display 1100 of such matrix type. FIG. 12 is a cross-sectional view taken along a line A-A in FIG. 10. As illustrated, longitudinal line electrodes 1101 and lateral line electrodes 1102 are arranged to cross at right angles. As one example, three lateral line electrodes and three longitudinal line electrodes are arranged, and the segments are connected at the intersections, respectively as in FIG. 12. Although the structure shown in FIGS. 11 and 12 have three line electrodes in each of the longitudinal and lateral directions for convenience of explanation, four or more line electrodes can be of course provided in each of the longitudinal and lateral directions. The lateral line electrodes 1102 are sequentially connected to ground potential GND, and the longitudinal line electrodes 1101 are selectively connected to VCC of the power supply to change a desired segment in cooperation with the sequential drive of the lateral line electrodes. The electrodes used are preferably flat stripe-shape electrodes. Wire type electrodes can be used, but have the difficulty to small-size, and thus this type cannot be so recommended.

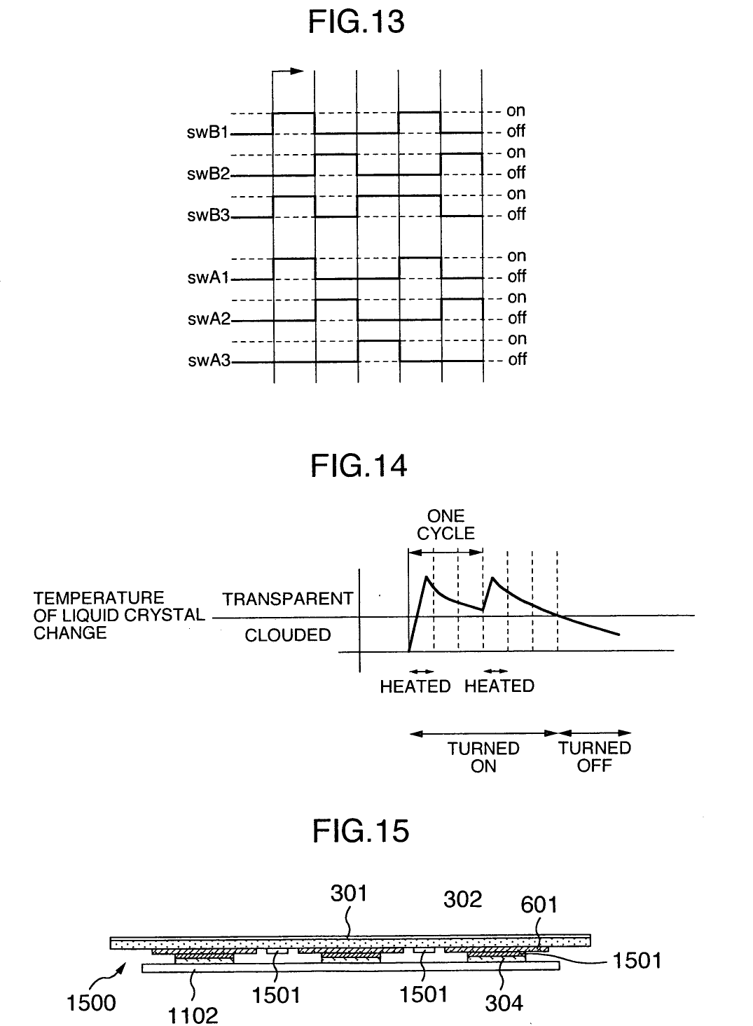

FIG. 13 is a timing chart of pulses for driving the switches (sw) A1 to A3, B1 to B3 shown in FIG. 11. The shaded segments of the polymer dispersed liquid crystal layer 302 as illustrated in FIG. 11 are heated to become transparent with the result that the color of the underlying thermal conduction plates 601 appears.

The interval of the pulses can be easily determined by previously calculating the heating period from the time for which the change of polymer dispersed liquid crystal 302 can be held as shown in FIG. 14.

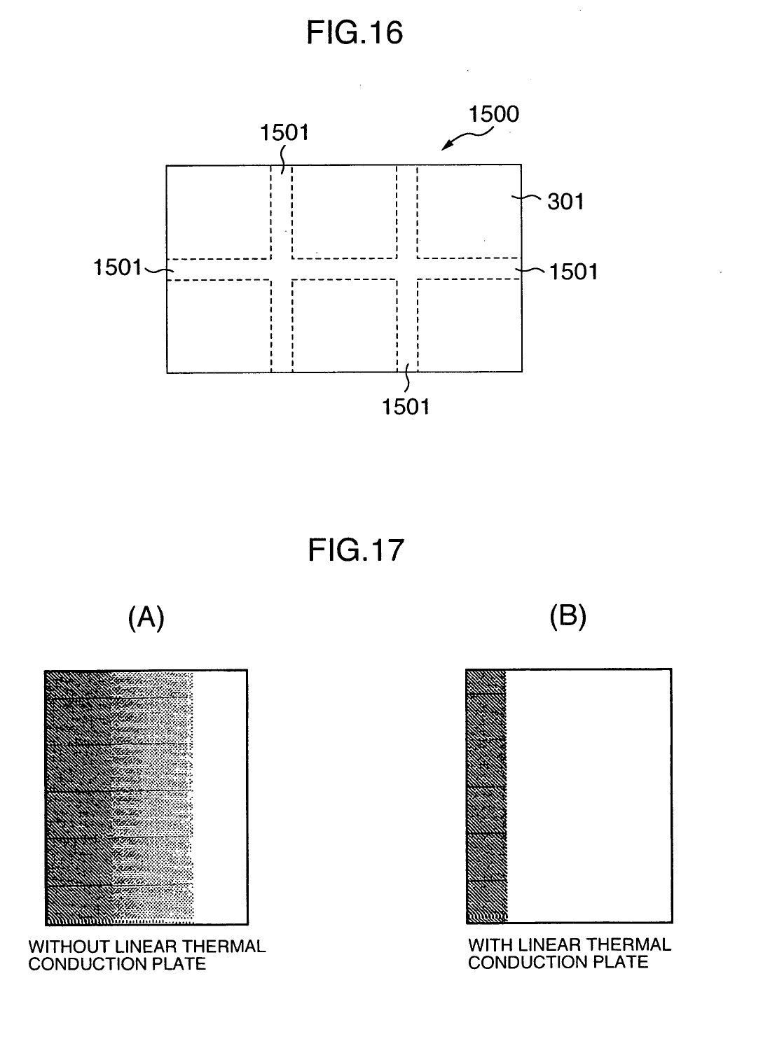

Although the protective film 301 and polymer dispersed liquid crystal layer 302 are provided for each segment in FIGS. 11 and 12, it is preferable to make those films and layers continuous because the separation of those layers for each segment is troublesome in the production. FIG. 15 is a cross-sectional view of one example of the matrix type liquid crystal display 1500 with the protective film 301 and polymer dispersed liquid crystal layer 302 formed as a continuous single sheet. FIG. 16 is a top view thereof. When the display with the protective film 301 and liquid crystal layer 302 formed in a continuous sheet is driven, heat is conducted between the segments, disturbing clear display. Thus, stripe-shape radiation plates 1501 of a certain width are provided in the longitudinal and lateral directions in order to sufficiently separate the segments of the matrix drive type. The stripe-shape radiation plates 1501 are arranged in the longitudinal and lateral directions to surround each segment independently. As a result, when a segment is heated by current, the generated heat is not transmitted to the adjacent segments, and thus clear displaying is not disturbed. The material of the strip-shape radiation plates 1501 should be selected to have a higher thermal conductivity than that of the thermal conduction plate 601. The greater the difference between the thermal conductivities of stripe-shape radiation plate 1501 and thermal conduction plate 601, the better results can be obtained. The thickness of the stripe-shape radiation plates 1501 is not particularly limited, but it is generally preferable to have a thickness within a range of 1 mm˜20 mm. If the thickness is less than 1 mm, satisfactory radiation effect cannot be expected. If the thickness is over 20 mm, the interval between the segments is increased, degrading the quality of the display.

FIGS. 17(a) and 17(b) show the effects of not using and using the stripe-shape radiation plates 1501, respectively. When the radiation plates 1501 are not provided, the generated heat is transmitted between the adjacent segments, making the boundary between the transparent and opaque portions unclear like gradation as illustrated in FIG. 17(a). When the radiation plates 1501 are provided, the heat is blocked by the radiation plate not to be transmitted between the adjacent segments, so that the boundary between the transparent and opaque portions can be clearly displayed.

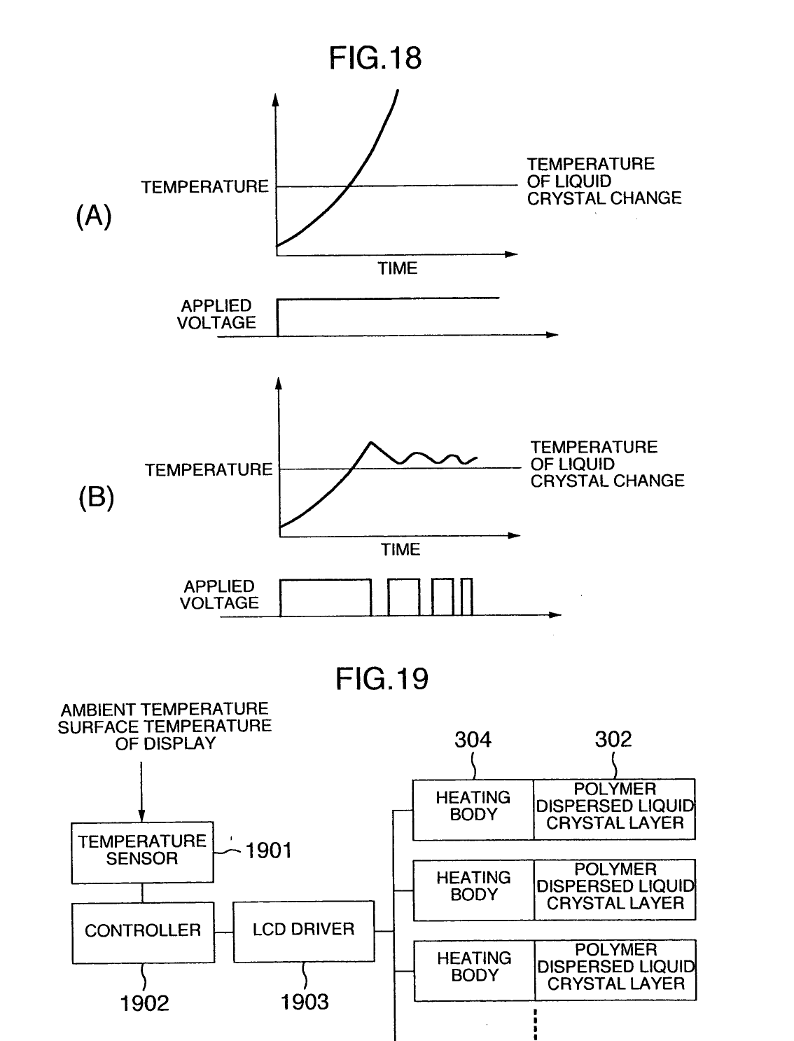

FIGS. 18(a) and 18(b) are graphs showing the relation between the applied voltage and the temperature of polymer dispersed liquid crystal layer 302 with a continuous voltage applied, and with a pulse voltage applied, respectively. When a continuous voltage is applied, since the temperature increases after arriving at the liquid crystal changing point as shown in FIG. 18(a), the liquid crystal 302 might be decomposed, deteriorating the display device. Thus, preferably as shown in FIG. 18(b), a continues voltage is applied until the temperature arrives at the liquid crystal changing point, and a pulse voltage with the width changed is applied after the temperature exceeds the liquid crystal changing point, thereby maintaining the temperature of the liquid crystal layer 302 approximately constant around the liquid crystal changing point.

FIG. 19 shows a method of determining the pattern of the pulse voltage width. The ambient temperature and display device surface temperature are detected by a temperature sensor 1901 and fed to a controller 1902 where an optimum pulse voltage pattern is calculated. The computed pattern is fed through an LCD driver 1903 to the heating unit 304. A method of calculating the pattern in the controller 1902 is to hold a table of paired temperature data and optimum voltage pattern within the controller 1902 as a ROM, but it is not particularly limited thereto.

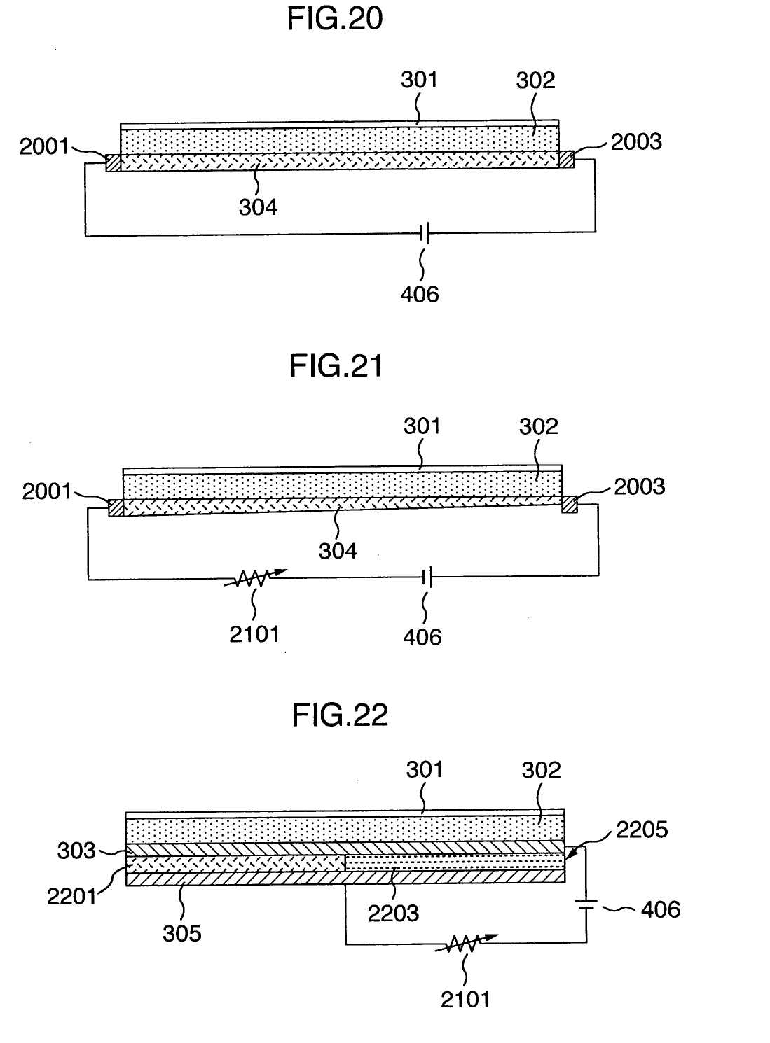

The structure of FIG. 3 has a pair of electrodes 303, 305 respectively provided up and down on both sides of the heating unit 304. Therefore, one electrode 303 is interposed between the liquid crystal layer 302 and the heating unit 304 so that the liquid crystal layer 302 is not made in direct contact with the heating unit 304. As shown in FIG. 20, it is possible that a pair of electrodes (a), (b) 2001, 2003 are connected to the right and left opposite ends of the heating unit 304, and that the liquid crystal layer 302 and the heating unit 304 are made in direct contact with each other. In this case, when the liquid crystal layer 302 is heated to become transparent, the heating unit 304 itself can be seen through the liquid crystal layer. When the heating unit 304 is blackish like carbon, the liquid crystal layer 302 exhibits a high contrast because of the difference to the white at the time of not heating. When the heating unit 304 is near white, the contrast between the transparent and opaque states of the liquid crystal layer 302 is sometimes reduced. Therefore, a visually satisfactory colored background plate (not shown) such as a color film (for example, lusterless black film) shown in FIG. 5(b) can be interposed between the liquid crystal layer 302 and the heating unit 304. As another example, a color paint (for example, lusterless black paint) can be coated on the surface of the heating unit 304. In the case of coating a color paint, information of letters, figures, patterns and/or symbols can be printed with the paint on the surface of the heating unit 304 so that the information can be exposed or hidden in accordance with the transparent and opaque states of the liquid crystal layer 302.

In addition, as shown in FIG. 21, the thickness of the heating unit 304 can be gradually increased or decreased in one direction to change the resistivity of the heating unit 304. The liquid crystal layer can be changed in mode by the voltage and current applied between the paired electrodes 2001, 2002. The voltage and current can be changed by, for example, inserting a variable resistor 2101 between the power supply 406 and the heating unit 304. The voltage applied between the electrodes (a), (b) 2001, 2002 is changed by varying the resistance value of the variable resistor, thus changing the amount of heat generated from the heating unit 304 to change the display mode. In other words, the liquid crystal layer 302 exhibits transparent and opaque modes. In addition to changing the thickness of the heating unit 304, the width or length of the heating unit can be changed to change the resistivity so that the same effect can be achieved.

Moreover, as shown in FIG. 22, a plurality of heating elements (a), (b) 2201, 2203 of different resistivities can be provided to form a heating unit 2205. The liquid crystal layer 302 can be changed to bring about three different modes of, for example, all turn-on, half turn-on and all turn-off by changing the amounts of the respective heating elements. If the number of kinds of heating elements is increased, the number of display modes can be further increased. By optimum change of these heating elements, it is possible to use the liquid crystal display of the invention as an indicator for detecting the voltage or current (for example, a meter for the remaining electricity in battery).

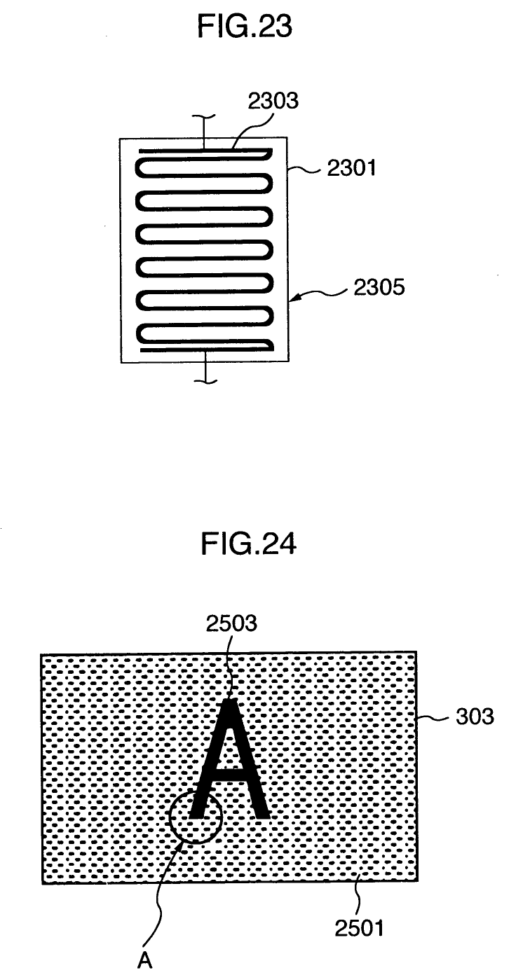

FIG. 23 is a top view of a heating sheet 2305 having a metal 2303 such as stainless steel formed on a plastic sheet 2301 and etched wavelike to have a certain resistivity. In addition, the polymer dispersed liquid crystal layer is formed on this heating sheet to produce a thin-type liquid crystal display.

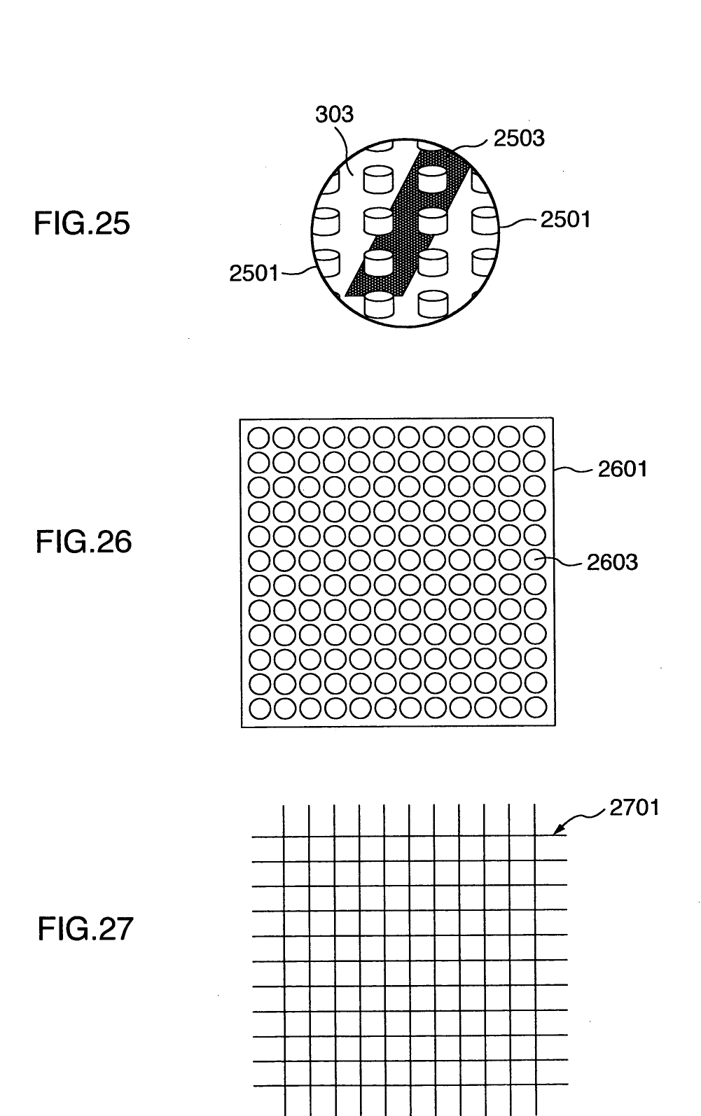

As described previously, a letter (for example, “A”) is printed with a black paint on the surface of the electrode (a) 303 and covered by the polymer dispersed liquid crystal layer 302. In this case, if the thickness of the liquid crystal layer 302 is too thin, the letter printed on the surface of the electrode (a) 303 is sometimes seen through the liquid crystal layer even at the time of not heating. Thus, as shown in FIGS. 24 and 25, projections 2501 about 1 mm high, for example, can be provided at an interval of, for example, 2˜3 mm over the surface of the electrode (a) 303, and the letter 2503 can be printed thereon. When the projection-provided surface of the electrode is covered by the polymer dispersed liquid crystal (a) 303 so as to be in close contact with each other, the letter can be well hidden by the irregular surface of the electrode (a) 303. That is, the letter 2503 printed on the surface of the electrode (a) 303 can be completely prevented from being seen through the liquid crystal layer 302. When the liquid crystal layer 302 is heated to become transparent by the heating sheet, the letter 2503 printed on the surface of the electrode (a) 303 appears and thus can be seen.

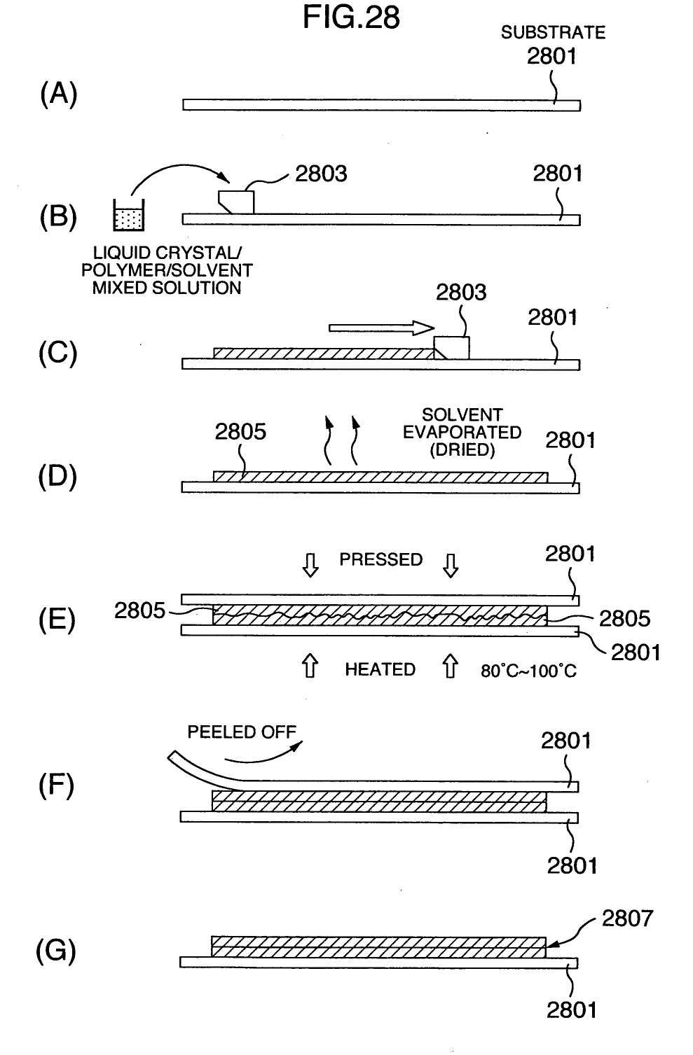

Another method of increasing the concealment without providing projections on the surface of the electrode (a) 303 is to insert a thermal conduction plate (see FIGS. 6(a) and 6(b)) between the electrode (a) 303 and the liquid crystal layer 302. As for example shown in FIG. 26, apertures 2603 are provided at an interval of, for example, 3 mm in the surface of a thermal conduction plate 2601. Alternatively, a lattice-like thermal conduction plate 2701 is provided as shown in FIG. 27. These thermal conduction plates are made of, for example, aluminum. The thermal conduction plate 2601 with apertures provided or the lattice-like thermal conduction plate 2701 is inserted between the electrode (a) 303 and the liquid crystal layer 302. The lattice-like thermal conduction plate 2701 is inserted to cross at right angles with the surface of the electrode (a) 303. Thus, the effect of the thermal conduction plate on the display can be reduced, and the concealment property by the polymer dispersed liquid crystal layer 302 can be improved at the time of not heating.

The liquid crystal used for the polymer dispersed liquid crystal layer 302 in the liquid crystal display 300 of the invention is not particularly limited as long as it is capable of discoloring or changing from opaque to transparent state or vice versa due to heat, or it has a response to heat. For example, smectic liquid crystal, nematic liquid crystal and cholesteric liquid crystal can be satisfactorily used for the polymer dispersed liquid crystal layer 302. It is preferable to use a liquid crystal of which the phase transition temperature (T_{NI}) is in the range of about 60° C.˜70° C.

The polymer of the polymer dispersed liquid crystal layer must be thermally stable and highly transparent in the thermal mode. When the conventional polymer of low glass transition temperature (T_{g}) is used as a binder resin, the polymer of low T_{g} is remarkably thermally deformed after the repetition of increase and decrease of temperature up to the phase transition temperature (T_{NI}) of the liquid crystal. As a result, the polymer dispersed liquid crystal display is deteriorated not only in its visual recognition characteristic but in its lifespan itself.

In the present invention, it is preferable to use a polymer capable of satisfying the condition of −20≦(T_{g}−T_{NI})≦20 as a binder resin. Therefore, if the phase transition temperature (T_{NI}) of the liquid crystal in the polymer dispersed liquid crystal layer is determined, the polymer used as a binder for the liquid crystal should be selected to have a glass transition temperature (T_{g}) satisfying the above condition.

When the thermally responsive polymer dispersed liquid crystal display is not heated (nematic phase mode), the liquid crystal is orientated along the polymer interface, and thus it becomes clouded or opaque because light is scattered from the polymer/liquid crystal interface. When the display is heated (isotropic phase mode), the polymer/liquid crystal interface is moved at the temperature of T_{g}=T_{NI}so that the liquid crystal around the interface is oriented random. Also, the liquid is easy to solubilize the polymer, and the thermal response speed can be relatively increased.

The present invention employs a polymer satisfying the condition of −20≦(T_{g}−T_{NI})≦20 as a binder resin. That is, the inventors found that a satisfactory thermal response can be obtained when the glass transition temperature of the polymer is equal or approximately equal to the phase transition temperature of the liquid crystal. This is probably because the liquid crystal molecules oriented in the polymer/liquid crystal interface solubilize into the polymer matrix. From the results of experiments, it was found that a combination of the polymer and liquid crystal particularly satisfying the condition of −20≦(T_{g}−T_{NI})≦20 remarkably increases this tendency and exhibits a high thermal response speed.

If a liquid crystal of which the phase transition temperature is, for example, 82° C. is used, it is possible to use as a binder resin for this liquid crystal an acrylic resin such as polymethyl methacrylate (PMMA) of which the glass transition temperature (T_{g}) is about 90° C. Since the temperature difference between T_{g} and T_{NI} is about 8° C., the polymer itself is subjected at a low possibility to thermal deformation even when it is exposed to a thermal cycle of repeating the increase and decrease of temperature up to the phase transition temperature (T_{NI}) of the liquid crystal, and thus the polymer dispersed liquid crystal display can be improved in its durability. In addition, since the acrylic resin is highly transparent and resistant to climate (resistant to UV), the polymer dispersed liquid crystal layer including this acrylic resin can be improved in its transparency and resistance to climate. Moreover, by using an acrylic resin such as PMMA satisfying the condition of −20≦(T_{g}−T_{NI})≦20, it is possible to promote the solubilizing between the liquid crystal and polymer in the polymer/liquid crystal interface at the time of raising the temperature, and improve the thermal response.

Other acrylic resins than PMMA that can be used in the invention are, for example, high-T_{g} methacrylate ester such as polymethyl methacrylate, polymethyl methacrylate tertiary butyl and polyethylene glycol dimethacrylate, denatured acrylic resin such as alkyd denatured acryl, polyester denatured acryl and silicon denatured acryl, and acryl copolymer using hard polymer such as styrene, methyl methacrylate, acrylonitrile and acryl amide. The T_{g} of these acrylic resins can be properly set by suitably selecting functional groups of various kinds of monomer, polymerization degree and copolymerization ratio.

Of course, other polymers than the above acrylic resins can be used as long as they satisfy the condition of −20≦(T_{g}−T_{NI})≦20. If, for example, the thermally responsive polymer dispersed liquid crystal display has a liquid crystal of which the phase transition temperature (T_{NI}) is around about 70° C., the polymer as the binder resin may be, for example, various kinds of polymer resins having T_{g} of 50˜90° C. such as polyvinyl butyral, polyester, polyurethane, vinyl chloride, vinyl acetate copolymer, silicone, polyvinyl alcohol, polyvinyl pyrolidone and cyanoethyl compounds of cyanoethyl pururan or the like, and the mixtures thereof. The above acrylic resins of which T_{g}is set to 50˜90° C. can also be used.

The weight ratio of the polymer and liquid crystal is important in the composition of polymer and liquid crystal for the polymer dispersion type liquid crystal layer 302 of the liquid crystal display 300 according to the invention. Increase of the liquid crystal content as compared with the polymer will enhance the thermal response of the polymer dispersed liquid crystal layer 302 that is formed by this composition. However, since the fluidity of the composition is too high when the polymer dispersed liquid crystal layer 302 is produced, the workability of coating on the electrode tends to decrease. On the contrary, increase of the polymer content as compared with the liquid crystal will increase the viscosity of the whole composition, and thus the composition can be easily coated on the electrode, or the productivity can be improved. However, the contrast is lowered, and the thermal response is reduced. Therefore, the weight ratio of the liquid crystal to the polymer in the polymer dispersed liquid crystal layer 302 according to the invention should be preferably set within the range of 1:10˜10:1, and more preferably within the range of 1:2˜3:1. The most preferable weight ratio of the liquid crystal to the polymer is 1:1.

In addition, the thickness of the polymer dispersed liquid crystal layer 302 is not particularly limited, but should be generally set within the range of 20 μm˜200 μm. If the thickness is less than 20 μm, satisfactory display effect cannot be expected. If the thickness is over 200 μm, the thermal response speed becomes slow, or fast display is difficult. Also, it becomes difficult to make the thickness uniform.

The polymer dispersed liquid crystal layer 302 of the invention is generally known by those skilful in the art, and can be produced by the liquid crystal layer forming methods commonly or ordinarily used by those skilful in the art, for example, capsulation, polymerization phase separation, thermal phase separation and solvent evaporation phase separation.

FIGS. 28(a)˜28(g) show another example of the manufacturing process for producing the polymer dispersed liquid crystal layer having a uniform thickness distribution, high thickness and high contrast. At process A, a substrate 2801 is prepared. The substrate 2801 is not particularly limited, and may be transparent or opaque. This substrate is made of, for example, glass, metal or plastic. It is preferable for this invention to employ a transparent or opaque plastic substrate. The plastic substrate can be not only produced at low cost as compared with the glass substrate, but can be formed to have a curved surface by its flexibility. Also, its wetability is better than the glass substrate. The plastic substrate that can be used in this invention may be, for example, polyethylene terephtalate, polyethylene naphthalate and polyether sulfone. The thickness of the substrate 2801 is not particularly limited, but the substrate should have a necessary and sufficient mechanical strength. The surface of the substrate 2801 on which the liquid crystal composition is coated can be rinsed with a proper cleaning agent such as solvent or treated by the irradiation of ultraviolet rays before the liquid crystal composition is coated on the surface.

At process B, a proper coating device such as a coater or applicator is filled with a liquid crystal composition formed of the mixture of liquid crystal, polymer and solvent, and this coating device is placed at around one end of the substrate.

Then, at process C, this coating device 2803 is quietly slid along the surface of the substrate at a constant speed toward the other end of the substrate. At this time, a polymer dispersed liquid crystal film 2805 of a certain thickness is coated on the substrate according to the gap between the lower blades (not shown) of the coating device 2803.

At process D, when the polymer dispersed liquid crystal film 2805 is dried by an ordinary method, the film-shaped polymer dispersed liquid crystal film 2805 is formed on the substrate 2801. The thickness of the dried polymer dispersed liquid crystal film 2805 is not particularly limited, but should be generally settled within the range of 20 μm˜200 μm. If the film thickness is less than 20 μm, there is a risk that pinholes are produced in the film. If the film thickness is over 200 μm, it is difficult to produce a uniform thickness.

The processes A to D are substantially the same as the manufacturing process for the conventional polymer dispersed liquid crystal display.

The polymer and liquid crystal of the polymer/liquid-crystal composition of the invention should be dispersed as uniformly as possible. Therefore, it is preferable to use a solvent in which all these components can be dissolved. Such solvent should be generally lipophilic. The solvent for the liquid crystal may be the same as or different from that for the polymer. However, when both the solvents are mixed, they should be compatible or miscible to each other. It should be avoided that when both the solvents are mixed, phase separation is caused by bad miscible condition. The solvents that can be used in the invention may be any one of aliphatic, aromatic, alicyclic and heterocyclic compounds. Specifically, it is preferable to use cellulose, toluene, xylene, cyclohexanone, acetone, methylethyl ketone, methyl isobutyl ketone, ethyl acetate, carbon tetrachloride, acetonitorile, pyridine or N,N-dimethylormamide ketone. A single solvent can be used or two kinds of solvents can be mixed and used. The solvents that can be used in the invention should be volatile.

The amount of solvent to be used is not particularly limited, but a necessary and sufficient amount of solvent can be used to dissolve the liquid crystal and polymer used in the invention. If an unnecessarily large amount of solvent is used even though it is favorable for the liquid crystal and polymer, it takes a very long time to dry the composition coated on the substrate. Also, unfavorable abnormal discharge and irregular display are caused by residual solvent. Actually, the amount of solvent to be used depends on various factors such as the solubilities of the selected liquid crystal and polymer, the easy-to-coat ability of the mixed solution, and drying time. Therefore, those who are skilful in the art can properly determine the amount of solvent to be used by considering each of the factors.

The above-mentioned processes A to D are repeated to produce a plurality of, for example, two or more, structures each having the polymer dispersed liquid crystal film 2805 supported on one side of the substrate 2801. Then, at process E one polymer dispersed liquid crystal film 2805 is overlapped upon another one 2805, and properly pressed against each other from the opposite sides of the substrates 2801 while heating at a temperature of about 80° C.˜100° C. so that both liquid crystal films can be bonded together. This compression bonding process can be properly performed by a laminate machine (for example, TOLMI-DX-350 model made by Tokyo Laminex Corp.). Even the pressure with which those films are bonded by hands can be easily determined by repeating experiments. By this compression bonding, the minute irregularities present on the surfaces of the polymer dispersed liquid crystal films 2805 can be flattened in the compression bonding interface so that a uniform junction can be formed. The compressing time for bonding both liquid crystal films is not particularly limited, but should be necessary and sufficient to completely bond both films. Those who are skilful in the art can easily determine this compressing time by repeating experiments.

At process F after the compression bonding, one of the substrates 2801 is peeled off from the bonded liquid crystal films 2805. This peeling operation can be executed by well known ordinary means such as air knife. The other peeling means may be of course employed.

Thus, at process G, a laminated polymer dispersed liquid crystal layer 2807 of which the thickness is about twice that of a single liquid crystal film 2805 can be formed on the substrate 2801.

The two polymer dispersed liquid crystal films 2805 bonded face to face at process E may be of the same kind or of different kinds. In addition, although two liquid crystal films 2805 are bonded as in FIGS. 28(a)˜28(g), three or more liquid crystal films 2805 may be bonded without limiting to the above example.

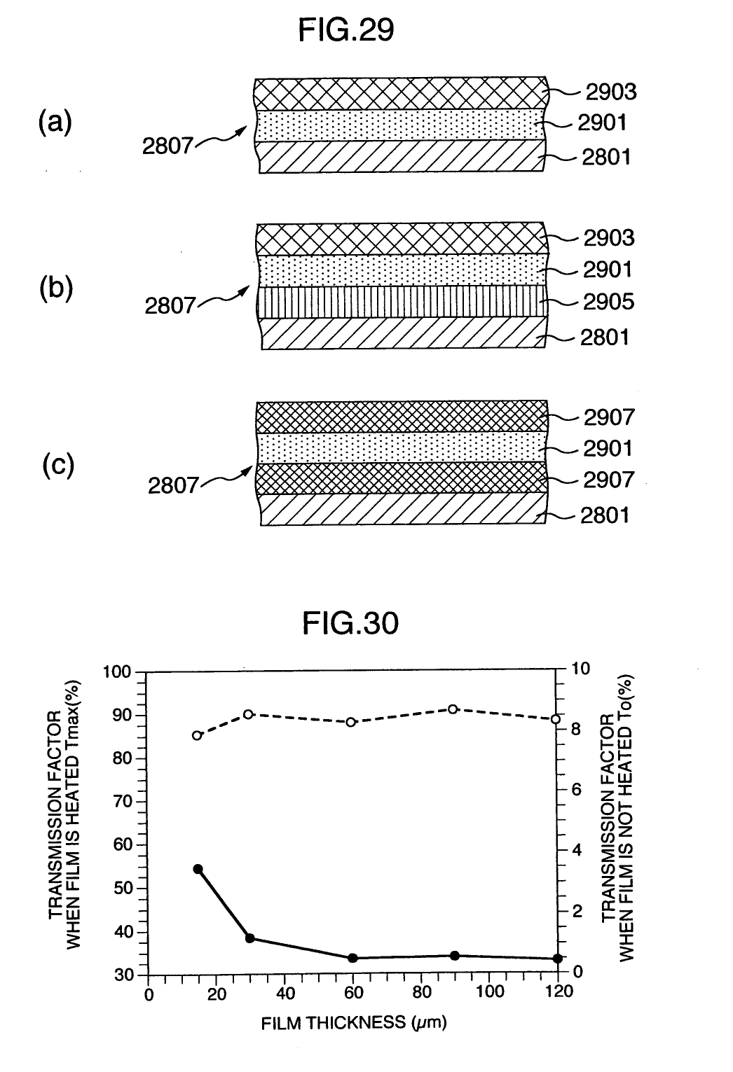

As, for example, shown in FIG. 29(a), a polymer dispersed liquid crystal film 2901 formed of polymethyl methacrylate (PMMA)/liquid crystal is first formed on the top of the substrate 2801, and then a polymer dispersed liquid crystal film 2903 formed of polymer/liquid crystal with ultraviolet-ray absorbent (UVA) added is formed on the top of this liquid crystal film 2901, thus producing the laminated polymer dispersed liquid crystal layer 2807 having durability against ultraviolet (UV) irradiation. The liquid crystal film 2901 of PMMA/liquid crystal has a high thermal response and high transparency, but it is liable to degradation due to ultraviolet rays. The liquid crystal film 2903 of UVA-added polymer/liquid crystal is able to increase the durability against UV without reducing the transparency. The ultraviolet ray absorbent (UVA) may be materials based on bezophenone, benzotriazol, salicylate and cyanoacrylate. These absorbents (UVA) are well known, and described in, for example, book “Dictionary of Practical Plastics” edited by SANGYO TYOSAKAI (published Sep. 20, 1993). When a bezophenone compound is used as UVA, a preferable polymer is polyolefin. When a benzotriazol compound is used as UVA, a preferable polymer is acrylonitrile-butadiene-styrene copolymer (ABS), polystyrene, polyurethane, polyvinyl chloride, polyolefin, polycarbonate, polyethylene terephtalate, polyoxymetylene acetal or polymetyl methacrylate (PMMA).

As shown in FIG. 29(b), it is possible to form a polymer dispersed liquid crystal film 2905 of polyester or urethane/liquid crystal on the top of the substrate 2801, the polymer dispersed liquid crystal film 2901 of PMMA/liquid crystal on the top of the liquid crystal film 2905, and then the polymer dispersed liquid crystal film 2903 of elastomer or acryl epoxy/liquid crystal on the top of the liquid crystal film 2901, thus producing the laminated polymer dispersed liquid crystal layer 2807 having durability against ultraviolet irradiation (UV) and resistance to thermal shock. If only the resistance to thermal shock is required, the liquid crystal film 2903 may be omitted. The polymer constituting the polymer dispersed liquid crystal film for the purpose of improving the resistance to thermal shock may be amorphous polyolefin, polyetherimide, polyamide, polycarbonate, polysulfone, polyethersulfone or polyetherketone.

Moreover, as shown in FIG. 29C, it is possible to form a polymer dispersed liquid crystal film 2907 of a highly ductile resin (for example, butyral or polyester)/liquid crystal on the top of the substrate 2801, the polymer dispersed liquid crystal film 2901 of PMMA/liquid crystal on the top of the liquid crystal film 2907, and then the liquid crystal film 2907 on the top of the liquid crystal film 2901, thus producing the three-layer polymer dispersed liquid crystal layer 2807. Since the viscosity of the liquid crystal film 2907 is larger than that of the intermediate film 2901, the whole liquid crystal layer 2807 is flexible against a deforming stress such as folding or bending, and thus has high mechanical strength. The polymer to be used as a material capable of increasing the flexibility may be vinyl chloride, polyethylene, polypropylene, polyester or elastomer such as styrenebutadiene rubber, butadiene rubber or silicon rubber.

The present invention will be described in detail about the embodiments given below.

Embodiment 1

To produce the liquid crystal display 300 of the structure shown in FIG. 3, polymethyl methacrylate (T_{g}=90° C., molecular weight=1.05×10⁵) was used as the polymer, and nematic liquid crystal (T_{NI}=82° C., Δn=0.253) as the liquid crystal. The mixture solution of the polymer and liquid crystal of which the weight ratio is 1:1 was coated on the PET substrate 301 to form the polymer dispersed liquid crystal layer 302 60 μm thick. Then, the electrodes and heating unit were combined with this layer to produce a liquid crystal cell A.

Embodiment 2

To produce the liquid crystal display 300 of the structure of FIG. 3, high-T_{g} polymethyl methacrylate (T_{g}=100° C., molecular weight=1.15×10⁵) was used as the polymer, and nematic liquid crystal (T_{NI}=82° C., Δn=0.253) as the liquid crystal. Then, the same conditions and operations as in the embodiment 1 were used and performed to produce a liquid crystal cell B.

### Comparative Example 1

To produce the liquid crystal display 300 of the structure of FIG. 3, polyvinyl butyral (T_{g}=50° C.) was used as the polymer, and nematic liquid crystal (T_{NI}=72° C., Δn=0.246) as the liquid crystal. The weight ratio of the polymer and liquid crystal was 1:1. Then, the same conditions and operations as in the embodiment 1 were used and performed to produce a liquid crystal cell C.

### Comparative Example 2

To produce the liquid crystal display 300 of the structure of FIG. 3, polytertiary butylmethacrylate (T_{g}=107° C.) was used as the polymer, and nematic liquid crystal (T_{NI}=82° C., Δn=0.253) as the liquid crystal. Then, the same conditions and operations as in the embodiment 1 were used and performed to produce a liquid crystal cell D.

### Comparative example 3

To produce the liquid crystal display 300 of the structure of FIG. 3, polyethylene glycol methacrylate (T_{g}=130° C.) was used as the polymer, and nematic liquid crystal (T_{NI}=82° C., Δn=0.253) as the liquid crystal. Then, the same conditions and operations as in the embodiment 1 were used and performed to produce a liquid crystal cell E.

The cells A, B, C, D and E produced in the embodiments and comparative examples were subjected to a thermal cycle test at around the opaque-transparent changing temperature. The result was that after the thermal cycles of ten thousand times the cells A, B, D and E were able to be changed from clouded mode to transparent mode without thermal deformation of PDLC film. However, the cell C had its PDLC film thermally deformed after the thermal cycle test of 1000 times, so that defective portions appeared in the display. From the results, it was confirmed that the display with the polymer satisfying the condition of −20≦(T_{g}−T_{NI})≦20 exhibited high resistance to the thermal cycle.

The following table 1 lists the measured results of the thermal response time exhibited when the cells A, B, C, D and E produced in the embodiments and comparative examples were heated. The values in the “THERMAL RESPONSE TIME” column are the time taken for the transmission factor (λ=555 nm) to change from the minimum to the maximum when each PDLC film was sandwiched by transparent electrode and heating unit and heated so that the temperature was raised at a constant speed.

TABLE 1

| | | | | THERMAL |
|---|---|---|---|---|
| | | T_{NI} | T_{g} − T_{NI} | RESPONSE |
| | T_{g} (° C.) | (° C.) | (° C.) | TIME (SEC) |
| CELL | 89 | 82 | 7 | 1 |
| A (EMBODIMENT 1) | | | | |
| CELL | 100 | 82 | 18 | 2 |
| B (EMBODIMENT 2) | | | | |
| CELL | 60 | 72 | −22 | 3 |
| C (COMPARATIVE 1) | | | | |
| CELL | 107 | 82 | 25 | 6 |
| D (COMPARATIVE 2) | | | | |
| CELL | 130 | 82 | 48 | 7 |
| E (COMPARATIVE 3) | | | | |

From the results of Table 1, it will be understood that the thermal response speeds of the cells A and B satisfying −20≦(T_{g}−T_{NI})≦20 are relatively faster than those of the cells D and E of (T_{g}−T_{NI})<20° C., and that this tendency is remarkable at T_{g}−T_{NI}=20° C. It was experimentally confirmed that the cell using the polymer of −20≦(T_{g}−T_{NI})≦20 was improved in its thermal response. The cell C of T_{g}−T_{NI}<−20 is by no means inferior to the cells A and B with regard to the thermal response speed, but inferior to those in the resistance to thermal cycle.

The production of a liquid crystal display having the laminated polymer dispersed liquid crystal layer according to the invention will be described in detail.

Embodiment 3

The following materials were mixed and well stirred with a homogenizer at room temperature for 15 minutes to produce a polymer dispersed liquid crystal composition solution.

Polymer: polymethyl methacrylate . . . 5 weight part

Liquid crystal: cyanobiphenyl-based E-8

made by B.D.H. Corp . . . 5 weight part

Solvent: acetone . . . 90 weight part

This mixture solution was coated on a PET film by an applicator to form a polymer dispersed liquid crystal film 15 μm thick. The thickness of the liquid crystal layer was increased by superimposing liquid crystal films according to the lamination method of the invention. The lamination of liquid crystal films was made by compression bonding at 80° C. for one minute on the apparatus, TOLAMI-DX-350 that came onto the market from Tokyo Laminex Corp. Various different samples were prepared by changing the number of laminated liquid crystal films, and the transmission factors of those samples at the time of heating and not heating were measured. The results are shown in FIG. 30 and Table 2.

TABLE 2

| | NUMBER | | | |
|---|---|---|---|---|
| | OF | FILM | | TRANSMISSION |
| | LIQUID | THICK- | TRANSMISSION | FACTOR WHEN |
| | CRYSTAL | NESS | FACTOR WHEN | NOT HEATED |
| SAMPLE | FILMS | (μM) | HEATED (%) | (%) |
| A | 1 | 15 | 85.5 | 3.5 |
| B | 2 | 30 | 89.2 | 1.2 |
| C | 4 | 60 | 87.7 | 0.5 |
| D | 6 | 90 | 90.3 | 0.5 |
| E | 8 | 120 | 88.0 | 0.4 |

From the results of FIG. 30 and Table 2, it will be understood that the transmission factor at the time of not heating is reduced, or opaqueness is improved, by laminating the liquid crystal films up to four layers, while the transmission factor at the time of heating is not greatly changed. Thus, the estimated contrast ratios of the single film of no lamination (15 μm thick), two-layer lamination (30 μm thick) and four-layer lamination (60 μm thick) are 24:1, 74:1 and 175:1, respectively. The contrast ratio of the four-layer lamination is remarkably increased. When the number of laminated layers is over four, for example, 6 (the film thickness is 90 μm) and 8 (the film thickness is 120 μm), the contrast ratios are 180:1 and 220:1, respectively, which are substantially equal to or somewhat increased as compared with that of the four-layer lamination. Therefore, it can be considered the best to select the most effective four-layer lamination of 60 μm thickness as a polymer dispersed liquid crystal layer.

### INDUSTRIAL APPLICABILITY

According to the invention, since a thermal-responsive polymer dispersed liquid crystal display has electrodes and thermal conduction plates by which heat can be controlled as described above, the irregular display and low response speed due to the low thermal conductivity of the polymer can be changed for the better. In addition, the matrix type liquid crystal display can be improved so as to be able to prevent the display elements from deteriorating and to clearly display by inserting heat radiation plates between the segments and by employing a driving method suitable for the polymer dispersed liquid crystal.

Moreover, according to the invention, since the polymer dispersed liquid crystal layer has the polymer used as a binder resin capable of satisfying the condition of −20≦(T_{g}−T_{NI})≦20, the polymer itself is hardly subjected to thermal deformation even if it is exposed to the thermal cycle of the increase and decrease of temperature up to the phase transition temperature (T_{NI}) of the liquid crystal. Therefore, not only the polymer dispersed liquid crystal display can be improved in its durability, but the polymer dispersed liquid crystal layer can be improved in its resistance to climate and thermal response.

Furthermore, according to the invention, a single-layer polymer dispersed liquid crystal layer having a uniform and high thickness and its contrast improved can be produced by bonding a plurality of separately formed polymer dispersed liquid crystal films face to face in turn. Also, a laminated polymer dispersed liquid crystal layer having excellent characteristics such as high contrast, high durability against ultraviolet irradiation, good flexibility and high resistance to thermal shock can be produced by changing the kinds of laminated polymer dispersed liquid crystal films.

1. A method for controlling a liquid crystal display having disposed therein a polymer dispersed liquid crystal layer with a composition of a polymer and a liquid crystal, comprising steps of:
controlling temperature of said polymer dispersed liquid crystal layer formed on a heating unit by controlling current flowing through said heating unit wherein the glass transition temperature (T_{g}) of said polymer used with said liquid crystal and the phase transition temperature (TNI) of said liquid crystal satisfies the condition of −20≦(T_{g}−T_{NI})≦20, and wherein said polymer is a thermoplastic resin so that the temperature of said polymer dispersed liquid crystal layer is below a transition temperature where liquid crystal transfers between states of opaque and transparent, placing said polymer and said liquid crystal under phase separation,
controlling the temperature of said polymer dispersed liquid crystal layer above said transition temperature by controlling current flowing through said heating unit, placing said polymer to solubilize said liquid crystal.

2. A method for controlling a liquid crystal display according to claim 1, wherein said heating unit is provided between a pair of electrodes, and said polymer dispersed liquid crystal layer is provided on one of said pair of electrodes.

3. A method for controlling a liquid crystal display according to claim 1, wherein said heating unit is provided between a pair of electrodes, and said polymer dispersed liquid crystal layer is provided directly on said heating unit.

4. A method for controlling a liquid crystal display according to claim 1, wherein said polymer is a thermoplastic resin, and the glass transition temperature (T_{g}) of said polymer used with said liquid crystal is close to the phase transition temperature (TNI) of said liquid crystal, satisfies the condition of −20≦(T_{g}−T_{NI})≦20.

5. A method for controlling a liquid crystal display according to claim 4, wherein said polymer is an acryl-based resin.

6. A method for controlling a liquid crystal display according to claim 5, wherein said acryl-based resin is polymethyl methacrylate.

7. A method for controlling a liquid crystal display according to claim 1, wherein the weight ratio of polymer:liquid crystal of said composition is in the range of 1:10 to 10:1.

8. A method for controlling a liquid crystal display according to claim 7, wherein the weight ratio of polymer:liquid crystal of said composition is in the range of 1:2 to 3:1.

9. A method for controlling a liquid crystal display according to claim 8, wherein the weight ratio of polymer:liquid crystal of said composition is 1:1.

10. A method for controlling a liquid crystal display according to claim 1, wherein a thermal conduction member is further provided under said polymer dispersed liquid crystal layer.

11. A method for controlling a liquid crystal display according to claim 10, wherein said thermal conduction member has a lattice shape.

12. A method for controlling a liquid crystal display according to claim 1, said liquid crystal display having matrix structure.

13. A method for controlling a liquid crystal display according to claim 1, wherein a colored background plate having a color different from that of said polymer dispersed liquid crystal layer is further provided under said polymer dispersed liquid crystal layer.

14. A method for controlling a liquid crystal display according to claim 3, wherein said polymer dispersed liquid crystal layer is provided directly on said heating unit having a uniform thickness.

15. A method for controlling a liquid crystal display according to claim 3, wherein said polymer dispersed liquid crystal layer is provided directly on said heating unit of which the thickness is decreased or increased in the direction from one end to the other end, and a power circuit coupled to said pair of electrodes connected to the opposite ends of said heating unit has a variable resistor.

16. A method for controlling a liquid crystal display according to claim 2, wherein said heating unit is formed of a plurality of heating elements of different resistance values, and a power circuit coupled to said pair of electrodes connected to the opposite ends of said heating unit has a variable resistor.

17. A method for controlling a liquid crystal display according to claim 1, wherein said heating unit is formed of a plastic sheet that has a conductive metal formed and etched in a wave form.
